(19) United States
(12) Patent Application Publication
(10) Pub. No.: US 2018/0213193 A1
(43) Pub. Date: Jul. 26, 2018

(54) PORTABLE IMAGE PROJECTION SYSTEM AND METHOD

(71) Applicants: Norman Yakel, Regina (CA); Carol Casswell, Regina (CA)

(72) Inventors: Norman Yakel, Regina (CA); Carol Casswell, Regina (CA)

(21) Appl. No.: 15/878,184

(22) Filed: Jan. 23, 2018

Related U.S. Application Data
(60) Provisional application No. 62/449,656, filed on Jan. 24, 2017.

(51) Int. Cl. H04N 9/31

(52) U.S. Cl. CPC H04N 9/3173; H04M 1/0202; H04N 9/3179

(57) ABSTRACT

A portable image projection system that includes a projection system, a communication network interface, a projection lens and a mounting arm. The communication network interface is capable of wirelessly communicating with a communication network for receiving an image. The projection lens is capable of projecting the image. The mounting arm operably attaches the projection lens to the projection system. The mounting arm enables the projection lens to be rotated in a first direction and a second direction, which is different than the first direction.

### REFERENCE TO RELATED APPLICATION

This application claims priority to Provisional Applic. No. 62/449,656, filed on Jan. 24, 2017, the contents of which are incorporated herein by reference.

### FIELD OF THE INVENTION

This invention is in the field of digital cameras and other similar portable image handling devices. More specifically, the invention relates to portable image handling devices that include an integrated projector for projecting images onto an external surface.

### BACKGROUND OF THE INVENTION

The widespread use of digital photography can be credited with creating an enhanced role for digital imagery in communications or educational media. While visual media have always been a strong communications channel for educational or other purposes, the increased comfort level amongst key audiences, from consumers through to educators, with digital photography, digital video and digital image manipulation provides a strengthened role for the use of digital imagery as an educational tool. The use of digital imagery as a demonstrative aid however would be further enhanced by the use or availability of an integrated device that would allow for rapid and user-friendly capture, manipulation and display of images from various sources.

The widespread availability of digital cameras in many different types of electronic devices has further fed the increasing popularity of digital photography. Many different types of hardware devices currently include digital cameras for the capture of still or video images, including cameras themselves as well as portable music players, cell phones and other portable entertainment devices. Widespread availability of digital cameras makes it easy to capture digital photographs or other images for subsequent storage or review.

Even simply as a personal or social tool for the viewing of images, image capture or storage, these devices have become widely available and easily used. One of the limitations to the use of an image-capture or storage device such as a digital camera, smart phone or the like at present, is the limited ability to display images on the device in a large digestible format, since those devices typically include only a very small digital display.

Particularly where the use of digital imagery was to be incorporated strategically for a larger audience in an environment such as education, business or medical research or the like, it is likely the case that the best type of image display or output hardware which could be used would be a stand-alone projector of some type since this would allow for the provision of a large-format display that many people could simultaneously view.

There are certain digital cameras available that do presently provide for an interface to a television or the like so that the camera could be connected to an external display unit for the viewing of captured digital photographs without the need for uploading those photographs to a computer. However, insofar as even those types of units require the connection of the camera to an external device for the purpose of displaying captured digital images, it is believed that an integrated display device with a digital camera would be a desirable hardware enhancement.

Overall having identified some of the platform technologies involved in the use or development of digital imagery in the context of communications or education, it is believed that a digital camera or other image storage device with an integrated image projector represents a novel enhancement over the state of image capture and display hardware available on the market today. Incorporation into that device of a storage medium and computer-processing hardware would allow for the display of captured images on the projector, as well as for the operation of resident image manipulation software that would make the device further desirable.

The user interface for image manipulation software resident in such a device could comprise the display and operation of the software and images via the integrated projector, along with whatever human interface device was desired. For example, in terms of the human interface and integrated keyboard, a pointing device or the like could also be included, or the ability to connect the integrated device to external human interface devices such as a computer keyboard or mouse could also be provided.

U.S. Pat. No. 9,405,174, which lists the same inventors as the present application, is directed to a portable image storage device with an integrated projector. The contents of this patent are incorporated herein by reference.

### SUMMARY OF THE INVENTION

An embodiment of the invention is directed to a portable image projection system that includes a projection system, a communication network interface, a projection lens and a mounting arm. The communication network interface is capable of wirelessly communicating with a communication network for receiving an image. The projection lens is capable of projecting the image. The mounting arm operably attaches the projection lens to the projection system. The mounting arm enables the projection lens to be rotated in a first direction and a second direction, which is different than the first direction.

An embodiment of the invention is directed to a method of projecting an image. A projection system is provided that includes a projection lens operably mounted thereto. An image is selected to display with the projection lens. The image is projected with the projection lens. The image has a first shape when projected onto a surface. The projection lens is rotated in a first direction. After rotation in the first direction, the image is modified so that the image has a second shape when projected onto the surface. The second shape is substantially the same as the first shape. The projection lens is rotated in a second direction that is different than the first direction. After rotation in the second direction, the image is modified so that the image has a third shape when projected onto the surface. The third shape is substantially the same as the first shape.

Another embodiment of the invention is directed to a method of projecting an image. A projection system is provided that includes a projection lens operably mounted thereto. An image is selected to display with the projection lens. The image is projected with the projection lens. The image has a first shape when projected onto a surface. The projection lens is rotated in a first direction. After rotation in the first direction, the image is modified so that the image has a second shape when projected onto the surface. The second shape is substantially the same as the first shape. An orientation of the projection system is changed with respect to the surface. The image is modified to be substantially the same as the first shape when projected on the surface.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a perspective view of a portable image projection system according to an embodiment of the invention.

FIG. 2 is a block diagram of the main components in the projection system.

FIG. 3 is a side view of the portable image projection system projecting an image at multiple vertical locations on a vertically-oriented surface.

FIG. 4 is a top view of the portable image projection system projecting an image at multiple vertical locations on a vertically-oriented surface.

FIG. 5 is a top view of the portable image projection system projecting an image at multiple horizontal locations on a vertically oriented surface.

FIG. 6a is a side view of a lens pivot mechanism positioned for horizontal movement in the portable image projection system.

FIG. 6b is a top view of the lens pivot mechanism.

FIG. 6c is a front view of the lens pivot mechanism.

FIG. 7a is a top view of the lens pivot mechanism positioned for vertical movement in the portable image projection system.

FIG. 7b is a side view of the lens pivot mechanism.

FIG. 7c is a front view of the lens pivot mechanism.

### DETAILED DESCRIPTION OF THE INVENTION

As outlined elsewhere herein, the primary concept of the present invention is to provide an image storage device that is portable and which includes an integrated projector so that the images can be displayed in a large format. As used herein, large format means that the image when measured diagonally has a size of greater than about 4 feet. In other embodiments, the image when measured diagonally has a size of greater than about 8 feet.

Insofar as the invention relates to a portable image storage device, any electronic device that is capable of storing the necessary data to render digital images, either stills or motion video, is contemplated within the scope of the present invention. Specifically what is contemplated as the two primary types of devices into which the integrated image projector of the present invention could be added are either mobile telephones, digital cameras or tablets.

Many mobile telephones now include digital cameras, or a stand-alone digital camera also has the necessary hardware and software to store and recall for display images from its memory. While the primary discussion in this application is projection of an image stored in the projection system, the concepts of the invention also apply to projection systems on which the image is not stored but rather is dynamically received by the projection system 10.

While any other number of different types of image storage devices, which could be any electronic hardware capable of the storage of image data such as MP3 players, personal digital assistants, or even a portable laptop computer, could also comprise the portable image storage device of the present invention, it is the mobile telephone and mobile phone embodiments that are demonstrated herein for the purpose of illustrating the present invention.

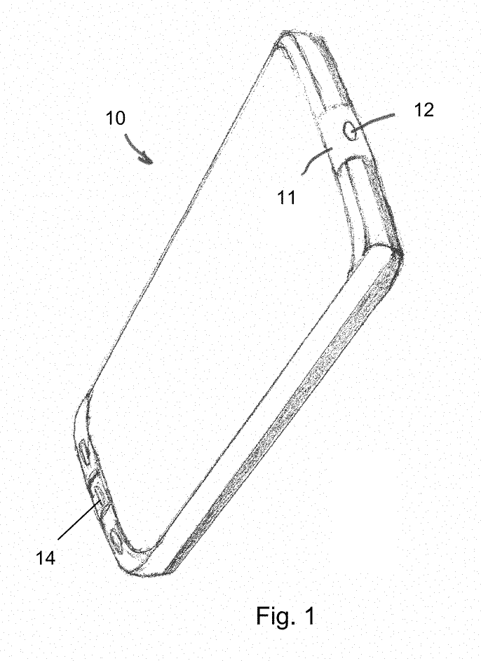

FIG. 1 illustrates an embodiment of the projection system 10 and the overall format of the devices of a mobile phone with a built-in projector 12. It may also be the case that a purpose-built system 10 could be manufactured in accordance with the present invention that could have optimized camera or projector components therein, or be more purpose-built for a particular market and the custom manufacturer of the projection system 10, in accordance with the remainder of the present invention is also contemplated within the scope hereof.

FIG. 1 is a perspective of the projection system 10 having a projection lens 12 pivotally mounted thereto. The projection lens 12 is illustrated in the figures as being mounted inside of an encasement 11 that protects the projection lens 12 during the use of the projection system 10. At least a portion of the encasement 11 is transparent so that the projection lens 12 can be recessed below the surface of the encasement 11 to thereby enhance the protection provided by the encasement 11.

The encasement 11 is attached to the other portions of the projection system 10 using a mounting arm 13, which are discussed in more detail herein. In certain embodiments, the encasement 11 is rotatably mounted to the mounting arm 13. In other embodiments, the encasement 11 is rotatable at least about 180 degrees with respect to the mounting arm 13. Such a configuration enables the projection lens 12 to move in various directions without obstruction.

The mounting arm 13 may be rotatably mounted in the projection system 10. In certain embodiments, the mounting arm 13 is rotatable up to about 360 degrees. In other embodiments, the mounting arm 13 is rotatable to about 180 degrees. In still other embodiments, the mounting arm 13 is rotatable to about 90 degrees. Rotation is mediated only by the creativity and/or imagination of the user.

The projection lens 12 may have the ability to automatically focus on the surface on which the image is to be projected. Such autofocus capabilities avoid the need for the person operating the projection system 10 to manually adjust the focus.

The projection system 10 tracks the vertical and horizontal orientation at which the image is projected and then modifies the manner in which the image is projected so that the projected image always has a substantially rectangular configuration. This modification can be based upon an orientation of the projection system 10 and/or an orientation of the projection lens 12. The projection system 10 may include a sensor system that determines a distance from the projection system to the surface 22 on which the image is projected. An example of one such suitable sensor system is a laser.

A skid-proof material may be applied to one of the surfaces of the projection system 10 to reduce the potential of the projection system 10 to inadvertently move with respect to a surface on which the projection system 10 is placed. In certain embodiments, the skid-proof surface is placed on a portion of the surface of the projection system 10 that is intended to be adjacent to the support surface during use of the projection system 10. An example of one suitable skid proof material is a silicon based medium, rubber or combinations thereof. In other embodiments, the projection system 10 may be physically attached to the support surface by means such as using a clamp or adhesive.

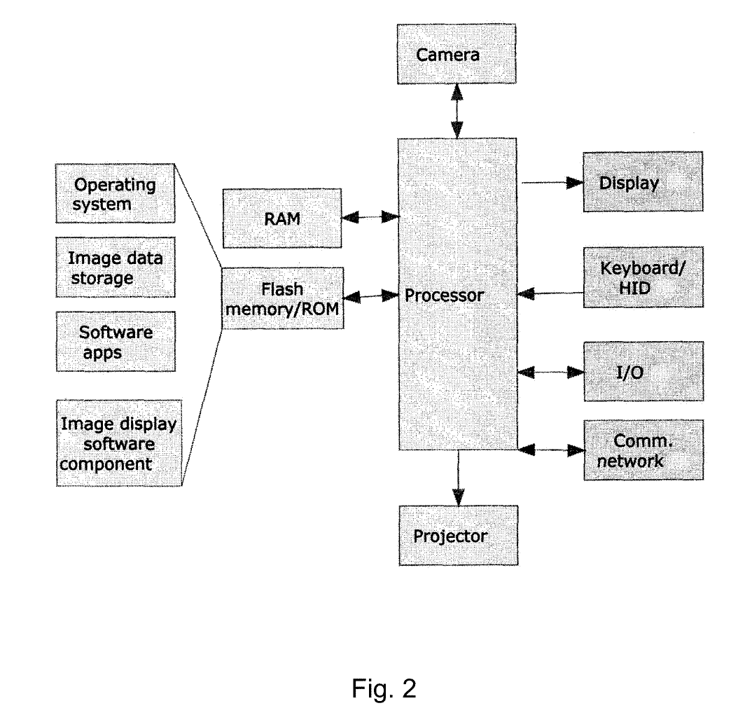

The internal components of the projection system 10 are schematically illustrated in FIG. 2. In certain embodiments, the projection system 10 includes a processor that is operably connected to a camera for capturing an image and a projector for displaying the image. The projection system 10 may include at least one of RAM and ROM memory on which an operating system, image data, software applications and image display software are stored. Depending on the desired functions of the projection system 10, the device may also include a display, an input device such as a keyboard, an input/output capability and a communications network connection.

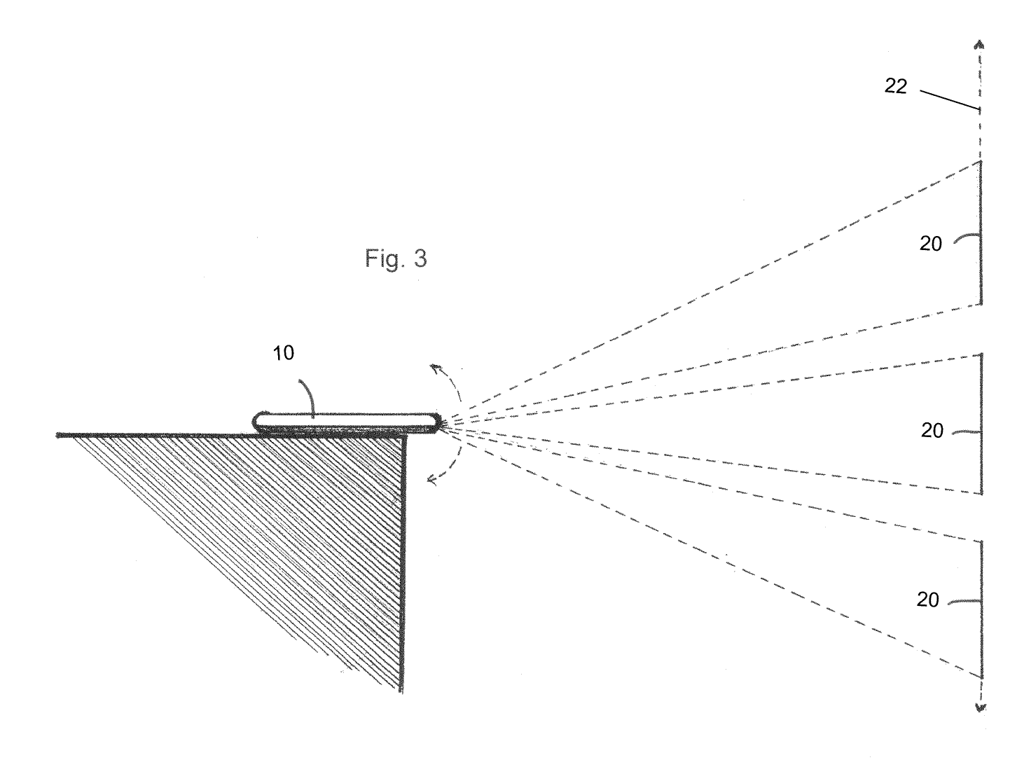

FIG. 3 illustrates the projection system 10 sitting on a fixed horizontal surface such as a table. This figure illustrates the vertical agility of the projection system 10 by pivoting the projection lens 12 up or down. The individual images 20 are representative of different locations during the rotation of the projection lens 12. This figure also illustrates the ability of the projection system 10 to project a substantially rectangular image 20 onto a surface 22 without the image 20 experiencing a keystone effect that is typically created when the conventional projectors are oriented at different angles with respect to the surface 22 on which the image 20 is projected.

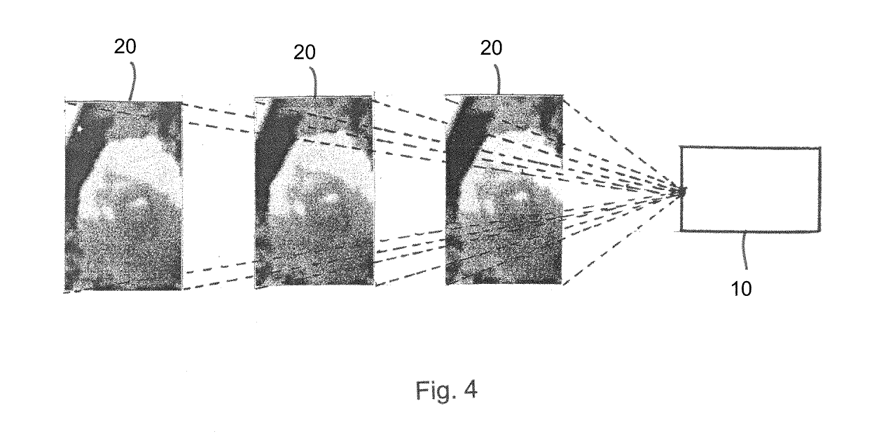

FIG. 4 illustrates vertical projection of the image 20 from a fixed location of the projection system 1 at various locations to the up and down features of the projection system 10. The individual images 20 are representative of different locations during the rotation of the projection lens 12. In certain embodiments, the projection lens 12 is rotatable over an angle of greater than about 90 degrees. In other embodiments, the projection lens 12 is rotatable over an angle of up to about 120 degrees.

The images at each of the locations in FIG. 4 are substantially similar. In particular, the images 20 each have a substantially similar rectangular shape and have a substantially similar height and width. Each of the images also has a similar quality and resolution. As the projection lens 12 is rotated, the projection system 10 modifies the image 20 that is being projected to compensate for the angular orientation of the projection lens 12.

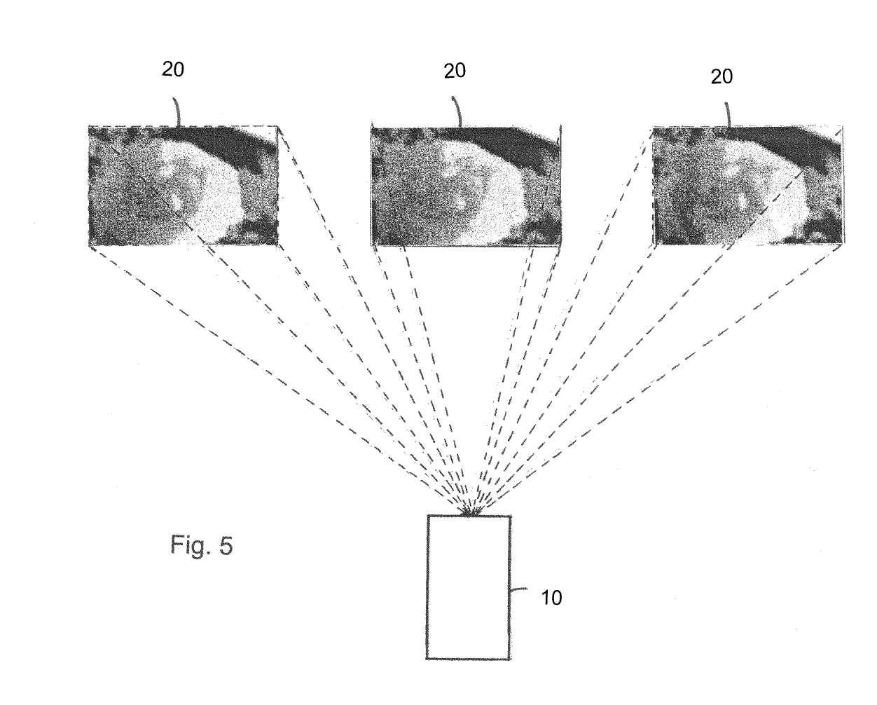

FIG. 5 illustrates horizontal projection of the image 20 from a fixed location of the projection system 10 at various locations to the left and right of the projection system 10. The individual images 20 are representative of different locations during the rotation of the projection lens 12. In certain embodiments, the projection lens 12 is rotatable over an angle of greater than about 90 degrees. In other embodiments, the projection lens 12 is rotatable over an angle of up to about 120 degrees.

The images 20 at each of the locations in FIG. 5 are substantially similar. In particular, the images 20 each have a substantially similar rectangular shape and have a substantially similar height and width. Each of the images also has a similar quality and resolution. As the projection lens 12 is rotated, the projection system 10 modifies the image 20 that is being projected to compensate for the angular orientation of the projection lens 12.

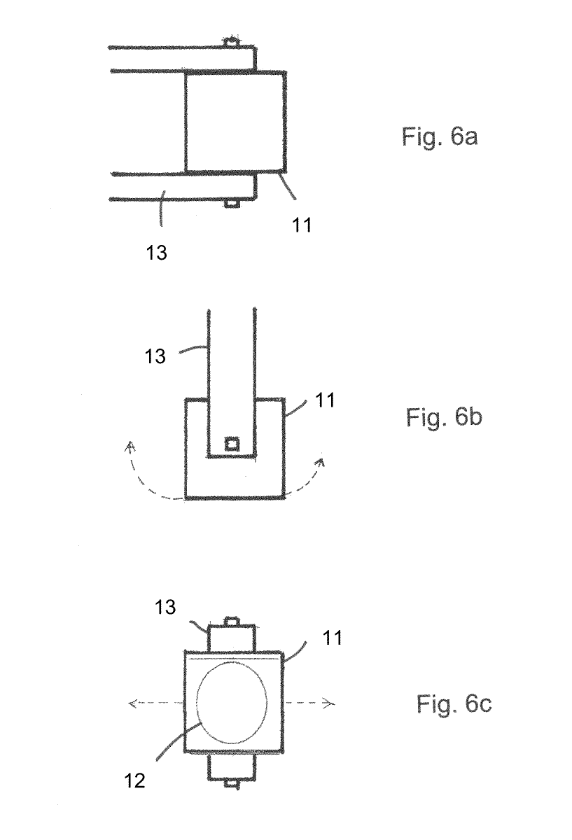

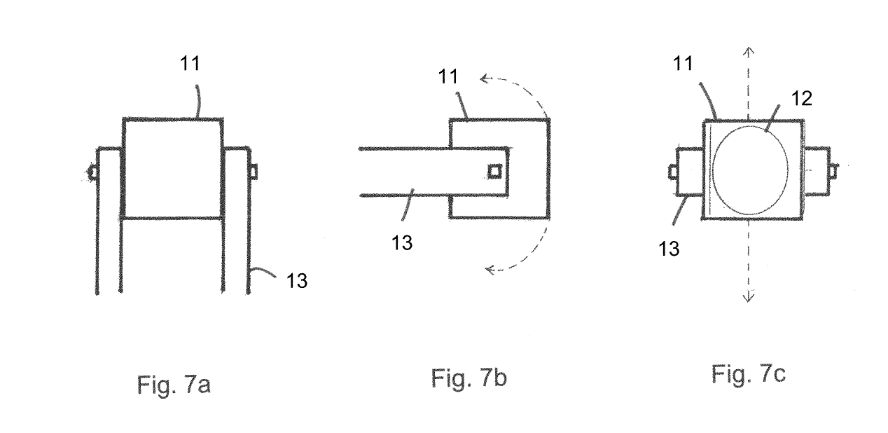

With respect to the projection system 10, rotating the mounting arm 13 approximately 90 degrees allows the projection lens 12 to change between the configuration illustrated in FIGS. 6a-6c to the configuration illustrated in FIGS. 7a-7c.

FIGS. 6a-6c illustrate pivoting of the projection lens 12 up and down in a horizontal movement. FIGS. 7a-7c illustrate pivoting of the projection lens 12 left and right in a vertical movement.

As an alternative to using projection system 10 to project a moving or stationary image, it is possible for the projection system 10 to be used to provide light similar to a conventional flashlight. In conjunction with such a use, the light may be emitted in a variety of colors and brightnesses.

The projection system 10 may also include the ability to sense the orientation of the projection system 10 with respect to a ground surface or with respect to the surface 22 on which the image 20 is projected and to modify the image based upon the sensed orientation so that the image 20 that is projected onto the surface 22 has a generally rectangular shape.

The image display software component of the present invention would be software components either integral with the operating system of the projection system 10 or otherwise stored within the memory of the projection system 10 that could, in conjunction with the other hardware and software components of the projection system 10, facilitate the projection of images by the projection lens 12 upon selection of one or more images from the memory of the projection system 10 by the user.

It will be understood that many different types of image display software components could be developed that would accomplish the objective of retrieving selected image data from the memory of the projection system 10 and properly processing or handling that in conjunction with the remainder of the software or hardware components associated with the projection lens 12 so that the projection lens 12 would project the selected image for display. Any image display software component that accomplishes this objective in the context of a similar device with image storage capacity and an integrated projector is contemplated within the scope of the present invention.

The portable image storage system 10 would include its components within an enclosure such as those which are shown—for example if the overall form factor and format of the device was that of a mobile telephone then the integrated projection lens 12 and remaining components of the present invention would be encased within the enclosure of the projection system 10. If a purpose-built projection system 10 were being manufactured some type of an enclosure would also be provided to protect and properly orient the various components.

The projection system 10 may include memory to store electronic data corresponding to newly-created or combined or in other ways manipulated images digital images. There might also potentially need to be other memory or storage on the projection system 10 which was capable of storing processor instructions, software or other unrelated information for the remainder of the device or which are necessary for the execution or operation of other functions of the projection system 10.

Various types of physical memory could be used dependent to a degree upon the remainder of the hardware used in the projection system 10, and all types of memory hardware which are capable of interfacing with the remainder of the electronic components selected for the projection system 10 are contemplated within the scope hereof.

The storage medium in the projection system 10 could either be solid-state storage such as a memory chip or the like, or if a larger degree or amount of storage was required then this storage could be feasibly integrated into the projection system 10 using a solid-state technology. The storage medium might also comprise a disk drive or some other such similar storage device which, when integrated along with the processor and other related software and hardware components, could provide for larger capacity image storage and software storage on the device. In the case of solid-state large-capacity storage, it will be understood that memory cards such as those currently used in digital cameras and the like are an ideal component for use in this capacity as well.

In various embodiments of the portable image storage projection system 10 of the present invention, where a camera 14 is included in the projection system 10, the camera 14 will be located in different locations on the back of the projection system 10. In some embodiments the camera 14 will be located in different locations on the back of the projection system 10, and the projection system 10 could have different configurations other than those shown. In some embodiments, where a camera 14 was included it may even be configured to pivot or be movable.

It is not necessary for the purpose of illustrating the present invention to outline in further detail all of the different circuitry involved in a digital camera 14 as basically the integration of the digital camera 14 to the overall projection system 10 in a fashion such that digital images could be captured by the camera 14 components for storage to the memory of the projection system 10 and subsequent display or manipulation are understood in the art. In particular, the projection system 10 enables the user to manipulate overlays with respect to the images as well as to manipulate the image while the image is being displayed on the projection system 10.

The key electronic component of the present invention is the projection lens 12 and related necessary video interface with the processor and remainder of the components of the projection system 10 to allow for large-format projection of images from the memory of the projection system 10 without the need for reliance on any external projection equipment or hardware.

In the near term, the desirable format for the overall projection system 10 will be to use a small-format LED-based projector within the device. There are now LED-based pico projectors that are becoming available on a standalone basis in the marketplace which allow for a projector of acceptable projection quality in a far smaller footprint and with a far smaller power consumption.

In fact it is believed that this type of a pico projector could be incorporated into a currently standard-sized mobile phone or camera case in accordance with the present invention. Any type of a projector that could be incorporated into an enclosure with a digital camera 14 and the other related components for image capture, manipulation and display are contemplated within the scope of the present invention.

In various embodiments of the portable image storage system 10 of the present invention, the projector 12 could be located in different locations on the projection system 10. In some embodiments the camera 14 will be located in different locations on the back of the projection system 10, and the projection system 10 could have different configurations other than those shown. In some embodiments, the projector 12 may even be configured to pivot or be movable.

By projecting images onto an external projection surface rather than on an integral display within the projection system 10, a larger image display will be accomplished without unnecessarily increasing the size of the projection system 10 itself. Any number of different types of surfaces could be used for image projection—there could be a screen which was close by onto which an optimized image could be projected or even a wall or some other surface could be used.

In addition to the projector 12, it is also possible that the projection system 10 would include additional external interfaces such as a printer port or the like to which the projection system 10 could be connected so that different types of output from the projection system 10 could be accomplished such as printing of captured or manipulated images and the like.

Also as is outlined elsewhere herein, if the projection system 10 contained a communications or network interface, it would be possible for output from the device to take the form of network transmission to either a printer or other output device or even a storage device connected to that network. It is contemplated in any event that a logical addition to certain embodiments of the projection system 10 would be a printer port or other similar external communication ports or computer buses and those are contemplated within the scope hereof.

The human interface of the projection system 10 as outlined elsewhere herein could take various forms, from a simple button or switch interface on the device in some fashion through to an on-screen keyboard or iconic interface of sorts in conjunction with the projector 12. As is described elsewhere herein, the human interface would be whatever type of an input device or combination of devices or interfaces was determined to be appropriate for interaction of the operator of the projection system 10 with the various functions thereof.

All such human input devices or variations are contemplated within the scope of the present invention. It is specifically contemplated that in certain more sophisticated image manipulation embodiments of the invention that the human input device would interact with menus or other options which would be displayed via the projector 12 for activation or operation by the operator.

In terms of the device, the next key element is the projector activator. What is intended by this terminology is to suggest the human interface by which a user of the projection system 10 could activate the projection of a particular image stored in the memory of the projection system 10 onto an external surface using the projector 12.

The projector activator/human interface is contemplated to be any combination of software or hardware components by which the user of the projection system 10 view and/or select one or more images from the memory of the projection system 10 for display by the projector 12.

The human interface that is used in association with the projection system 10 could take many different forms, as will be understood by someone aware of the varying types of electronic interfaces which can be developed for use with devices of this nature. Basically any type of an electronic interface that, on its own or in combination with other similar components on the projection system 10, would allow a user to interact with the projection system 10 and its resident software components for the purpose of selecting images for display is contemplated within the scope of the present invention. Specific items or ideas for the human interface device or interface include a button, a switch, a key, a dial, a touch pad, a touch screen, a haptic, holographic touch sensor, a key combination, a software device.

The human interface could be anything from a customized set of keys, switches or buttons which would allow a user to interact with the projection system 10, through to a connection for a keyboard or an integrated keyboard or mouse or the like, in a more traditional PC-oriented implementation. The human interface might even comprise a touchscreen somewhere on the device through which different menus and the like could be displayed and the user could interact by pressing on-screen on different selections.

In addition to the portable image storage device of the present invention, there is also disclosed a method of display of a digital image from a portable image storage device with an integrated projector and the other components outlined herein.

The initial step is the selection of an image file to be displayed. This would be done by the user using whatever type of human interface was integrated into the device and it is specifically contemplated that, for example, the human interface might be used to select from icons representing different images stored within the projection system 10, as will be shown on the menu selection screen which is being projected by the projector 12. In any event this first step would be the selection of an image for display in a basic image display transaction. Alternatively at the tail end of an image manipulation transaction the image may be directly displayed without the need to be selected from such a menu.

Once an image has been selected by the user of the projection system 10 from the storage memory of the projection system 10, use of the software resident in the projection system 10 would result in the retrieval of that image from the memory of the device for display. Retrieval of the image that was selected from the storage of the device by the software and the processor along with remaining or related components of the projection system 10.

Having identified and retrieved the selected image from memory or storage, the processor and remaining components of the projection system 10 would then process or send that image to the projector 12 for display. The human interface might also allow for adjustments of the projector 12 to adjust the display of the image, as appropriate. Again similar to the image capture transaction demonstrated above, this type of an image display transaction is not particularly complex.

The novelty however of this transaction, in conjunction with the configuration of the projection system 10 of the present invention and the image capture transaction demonstrated by FIG. 5, is the fact that there is an integrated large-format display device, namely a projector 12, contained within the device so that no external hardware is required for large-format display of images from the device.

Image capture could be conducted if the device included a camera 14 that is capable of capturing digital images such as photographs and storing them to memory within the projection system 10. As outlined generally above, for the purpose of the present disclosure and invention, the specific componentry of a digital camera or a digital image capture circuit will be obvious to one skilled in the art, and on that basis there will be a range of approaches which can be taken to providing that type of functionality without departing from the scope of the present invention.

The basic componentry of a digital camera includes a digital image sensor and a lens operatively connected to the remainder of the processor and the other circuitry of the projection system 10. Any combination of hardware or software which can accomplish the objectives of capturing digital images for storage or manipulation within the remainder of the projection system 10 is contemplated within the scope of this component.

As discussed elsewhere above from a cursory level, an optional element of the projection system 10 of the present invention is a communications interface by which the projection system 10 could either export or write images after capture or manipulation to an external network or storage location, or more likely could be used for the purpose of capturing external image assets for use in the manipulation and display of images by the remainder of the projection system 10. It is primarily contemplated that the communications interface would be a wireless network interface such as those used in laptop computers, PDAs and the like, to access a wireless LAN cloud in a location.

By virtue of this type of an interface, the projection system 10 could be used to, for example, download images from the Internet or elsewhere for use in manipulation and display on the projection system 10. In a circumstance where the communications interface was a network interface being used to access the Internet, or a similar external location, it may also be necessary for either the image manipulation software or other software components resident upon the projection system 10 to include a browser, but the inclusion of a browser or a browser type component to the image manipulation software resident upon the projection system 10 will be something that can be accommodated or easily incorporated by one skilled in the art of software design and as such is all contemplated within the scope of the present invention as well.

Beyond a wireless LAN interface, it is also conceivable that the device could actually include a wireless WAN interface instead. For example a GSM or CDMA wireless modem could be included in the device if it was desired to provide, obviously at a higher cost, a projection system 10 that could be used broadly and in locations where there might not otherwise be a local wireless network cloud available.

The communications interface could also be a hardwired interface rather than a wireless interface. For example it could be a hardwired network connection by which the device, with the necessary attendant network stack in the software of the projection system 10 could access a TCP/IP network or a network using another communications protocol, again to access external storage or even the Internet for the purpose of download or upload of images and assets to and from the projection system 10.

Finally the communications interface beyond being a network interface might also be simply a port by which an external storage device could be connected to the remainder of the projection system 10. For example it could comprise a USB port by which a memory stick or other external storage device or drive could be connected to the remainder of the projection system 10.

Any type of a communications interface that will accomplish the objective of either allowing for the export of captured images from the projection system 10 or more importantly the import of external assets into the memory of the projection system 10 for use in association with captured images in manipulation and display thereof, is contemplated within the scope of the present invention.

The present invention is not limited to a particular processor architecture, operating system, or computer programming language. Any limitations presented as a result of specific architectures, operating systems or computer programming languages are not intended as limitations of the present invention.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention as described. Thus, the present invention is not intended to be limited to only the exemplary embodiments shown herein, but is to be accorded the full scope consistent with the claims, wherein in reference to an element in the singular such as by use of the article “a” or “an” is not intended to mean “one and only one” unless specifically so stated, but rather “one or more.” All structural and functional equivalence to the elements of the various embodiments described throughout the disclosures that are known or may later come to be known to those of ordinary skill in the art are intended to be encompassed by the elements of the claims. Moreover, nothing disclosed herein is intended to be dedicated to the public regardless of whether such disclosure is explicitly recited in the claims.

1. A portable image projection system comprising:
a projection system;
a communication network interface that is capable of wirelessly communicating with a communication network for receiving an image;
a projection lens that is capable of projecting the image; and
a mounting arm that operably attaches the projection lens to the projection system, wherein the mounting arm enables the projection lens to be rotated in a first direction and a second direction, which is different than the first direction.

2. The portable image projection system of claim 1, and further comprising a projector actuator for causing an image to be projected by the projection lens and a camera.

3. The portable image projection system of claim 1, an orientation sensor that modifies the image based upon at least one of an orientation of the projection lens with respect to the projection system and an orientation of the projection with respect to a surface on which the image is projected.

4. A method of projecting an image comprising:
providing a projection system comprising a projection lens operably mounted thereto;
selecting an image to display with the projection lens;
projecting the image with the projection lens, wherein the image has a first shape when projected onto a surface;
rotating the projection lens in a first direction, wherein after rotation in the first direction, the image is modified so that when the image has a second shape when projected onto the surface, wherein the second shape is substantially the same as the first shape; and
rotating the projection lens in a second direction that is different than the first direction, wherein after rotation in the second direction, the image is modified so that when the image has a third shape when projected onto the surface, wherein the third shape is substantially the same as the first shape.

5. The method of claim 4, and further comprising sensing an orientation of the projection system with respect to the surface and modifying the image.

6. The method of claim 4, and further comprising transmitting the image to the projection system using a communication network.

7. The method of claim 4, wherein the first shape, the second shape and the third shape each have substantially the same size.

8. The method of claim 4, wherein the first shape, the second shape and the third shape are each defined by a top edge, a bottom edge, a first side edge and a second side edge, wherein the top edge and the bottom edge are both substantially perpendicular to the first side edge and the second side edge.

9. The method of claim 4, wherein the image comprises at least one of a single image and a video.

10. The method of claim 4, wherein the image comprises a single color.

11. The method of claim 4, wherein the first direction has a substantially vertical orientation and wherein the second direction has a substantially horizontal orientation.

12. The method of claim 4, wherein the rotation in the first direction is over an angle of at least about 180 degrees and wherein the rotation in the second direction is over an angle of at least about 180 degrees.

13. A method of projecting an image comprising:
providing a projection system comprising a projection lens operably mounted thereto;
selecting an image to display with the projection lens;
projecting the image with the projection lens, wherein the image has a first shape when projected onto a surface;
rotating the projection lens in a first direction, wherein after rotation in the first direction, the image is modified so that when the image has a second shape when projected onto the surface, wherein the second shape is substantially the same as the first shape; and
changing an orientation of the projection system with respect to the surface; and
modifying the image to be substantially the same as the first shape when projected on the surface.

14. The method of claim 13, and further comprising transmitting the image to the projection system using a communication network.

15. The method of claim 13, wherein the first shape, the second shape and the third shape each have substantially the same size.

16. The method of claim 13, wherein the first shape, the second shape and the third shape are each defined by a top edge, a bottom edge, a first side edge and a second side edge, wherein the top edge and the bottom edge are both substantially perpendicular to the first side edge and the second side edge.

17. The method of claim 13, wherein the image comprises at least one of a single image and a video.

18. The method of claim 13, wherein the image comprises a single color.

19. The method of claim 13, wherein the first direction has a substantially vertical orientation and wherein the second direction has a substantially horizontal orientation.

20. The method of claim 13, wherein the rotation in the first direction is over an angle of at least about 180 degrees and wherein the rotation in the second direction is over an angle of at least about 180 degrees.
